(19) United States
(12) Patent Application Publication
(10) Pub. No.: US 2016/0063596 A1
(43) Pub. Date: Mar. 3, 2016

(54) AUTOMATICALLY GENERATING READING RECOMMENDATIONS BASED ON LINGUISTIC DIFFICULTY

(71) Applicant: Kobo Incorporated, Toronto (CA)

(72) Inventors: Benjamin LANDAU, Toronto (CA); Inmar Ella GIVONI, Toronto (CA)

(21) Appl. No.: 14/470,018

(22) Filed: Aug. 27, 2014

(51) Int. Cl. G06Q 30/06

(52) U.S. Cl. CPC G06Q 30/0631; G06F 17/21

(57) ABSTRACT

System and method of automatically generating recommendation digital content works to reader based on the reading difficulty thereof, and more specifically linguistic difficulty. According to embodiments of the present disclosure, the reading difficulty level of each reference digital content work or candidate recommendation digital content work is graded through an automated process by using a difficulty model. The difficulty model can be established through a machine learning process and correlates reading difficulty with a plurality of attributes, including linguistic attributes and/or reader behavior attributes.

### TECHNICAL FIELD

The present disclosure relates generally to the field of electronic content applications and, more specifically, to the field of user interfaces for electronic reader applications.

### BACKGROUND

The use of electronic devices to read books, newspapers and magazines has become increasingly commonplace due to the numerous significant advantages afforded by such devices over conventional paper print. For example, comparing to paper print, an electronic reading device can hold much a greater amount of information, allow immediate access to new books, personalize the reading display format, and facilitate night reading, etc. Electronic reading devices can be implemented as dedicated reading devices, e.g., e-readers, as well as general-purpose electronic devices such as desktops, laptops and hand-held computers, smartphones, etc.

Presenting a recommended list of books to target users has become increasingly important for e-commerce companies to effectively attract and retain reader-consumers. The existing recommendation systems typically discover books for recommendation based on characteristics of books read by a target user, such as author, subject matter, content relatedness, genre, and so on. The same information can also be acquired from a target user's reading profile.

Many book readers favor reading books that are considered to be linguistically difficult and so intellectually stimulating. Parents and teachers often need to find books of varying difficulty levels for the children to monitor and help them advance in their reading skills. Unfortunately, conventional recommendation systems lack the mechanism of automatically determining linguistic difficulty of reading materials. Difficulty levels of books are typically evaluated manually, e.g., by authors, educators, linguists, editors, etc. Manual evaluation processes are time consuming and utilize varying and inconsistent evaluation standards and metrics, thus inevitably yielding unreliable results. Moreover, currently, the books assigned with difficulty levels are limited to books used by education or research institutions, such as children's books and text books. Importantly, difficulty level information for fictional books or alike is usually unavailable to readers.

### SUMMARY OF THE INVENTION

Therefore, it would be advantageous to provide an automated mechanism of recommending reading materials based on the reading difficulty thereof. If would be advantageous to provide this functionality in conjunction with an e-reader application.

Embodiments of the present disclosure employ a computer implemented method of automatically discovering digital content works (or digital contents) for recommendation based on the reading difficulty thereof. A preferred difficulty level of a target user is estimated based on his or her current reading, reading history or reading profile. Then recommendation digital contents are selected from candidate digital contents based on their reading difficulty level and the user-preferred or specified difficulty level. A difficulty level of a respective candidate digital content can be automatically determined using a difficulty model that correlates reading difficulty with a set of linguistic and/or reader behavior attributes. Characteristics of the linguistics attributes can be obtained by processing the content of the candidate digital content. Characteristics of the reader behavior attributes can be obtained from statistics of previous reader behaviors with respect to the candidate digital content. The reading difficulty model may be established through a supervised machine learning process by using a corpus of training digital contents with known difficulty scores.

Therefore the selection of digital content works for recommendation is automatically tailored to a specific user's capability or preference with respect to linguistic difficulty. This can advantageously enhance the user reading experience as well as improve the marketing efficiency of a recommendation system.

According to one embodiment of the present disclosure, a computer implemented method of automatically discovering recommendation digital contents to a user comprises: (1) receiving a request to recommend one or more digital contents to a user; (2) determining a preferred difficulty level by the user; (3) in response to the request, automatically identifying a recommendation digital content based on the preferred difficulty level and a reading difficulty level of the recommendation digital content; and (4) presenting the recommendation digital content in a recommendation event.

The method may further comprise automatically determining the reading difficulty level of the digital content based on characteristics of a set of linguistic attributes. The reading difficulty level may be determined by (1) processing text content of the recommendation digital content to determine the characteristics of the set of linguistic attributes; (2) accessing a correlation between the set of linguistics attributes and reading difficulty; (3) deriving a reading difficulty index of the recommendation digital content based on the characteristics of the set of linguistic attributes and the correlation; and (4) determining the reading difficulty level based on the reading difficulty index.

The set of linguistic attributes may be selected from a group consisting of digital content length, average word length, average sentence length, vocabulary diversity, usage of verbs, usage of nouns, usage of adjectives, usage of bigrams and trigrams of parts of speech, frequency of parts of speech, frequency of punctuation, etc. The reading difficulty level may be further determined based on statistics of reader behaviors with respect to the digital content, such as reading time, rate of abandoning the digital content, and reader reviews. The correlation may be established using a machine leaning process. Determining the preferred difficulty level may comprise assessing a reading difficulty level of a currently-read digital content by the user, and wherein further the reading difficulty level of the recommendation digital content is greater than the reading difficulty level of the currently-read digital content.

In another embodiment of the present disclosure, a computer implemented method of assessing linguistic difficulty of digital contents comprises: (1) accessing contents of a corpus of digital contents, wherein each digital content of the corpus is associated with a known difficulty score; (2) accessing a set of features related to linguistics difficulty of digital contents; (3) determining values of the set of features for the digital content; and (4) based on known difficulty scores of the corpus of digital contents and values of the set of features for the corpus of digital contents, determining a relationship correlating the set of features and linguistic difficulty in accordance with a machine learning process.

In another embodiment of the present disclosure, a system comprises a processor; and memory coupled to the processor and comprising instructions that, when executed by the processor, cause the processor to perform a method of generating reading recommendations to users. The method comprises: (1) receiving a request to generate a plurality of recommendation digital contents to a user; (2) determining a preferred difficulty level by the user; (3) responsive to the request, automatically identifying a recommendation digital content based on the preferred difficulty level and a reading difficulty level of the recommendation digital content; (4) rendering an on-screen graphical user interface (GUI) for display; and (5) presenting the recommendation digital content within the on-screen GUI.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary computer implemented system configured to automatically generate reading recommendations based on reading difficulty in accordance with an embodiment of the present disclosure.

FIG. 2 is a flow chart depicting an exemplary computer implemented method of automatically presenting difficulty-based recommendation books to users in accordance with an embodiment of the present disclosure.

FIG. 3 is a flow chart depicting an exemplary computer implemented method of automatically establishing a difficulty model using a machine learning process in accordance with an embodiment of the present disclosure.

FIG. 4 is a block diagram illustrating an exemplary computer implemented process of establishing a difficulty model and utilizing the model to determine a difficulty score of a book in accordance with an embodiment of the present disclosure.

FIG. 5 is a block diagram illustrating an exemplary computing system including an automated recommendation generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Automatically Generating Reading Recommendations Based on Linguistic Difficulty

Overall, provided herein are systems and methods of automatically generating a listing of recommendation digital contents to readers based on the reading difficulty of the digital contents, and more specifically the linguistic difficulty thereof. According to embodiments of the present disclosure, the reading difficulty level of each reference digital content or candidate recommendation digital content is advantageously graded through an automated process by using a difficulty model. The difficulty model can be established through a machine learning process and correlates reading difficulty with a plurality of attributes, including linguistic attributes and/or reader behavior attributes.

Although some embodiments of the present disclosure are described in detail with reference to the terms of “book” and “book content,” the present disclosure is not limited by any specific form, length, format or language of digital contents used as reference or recommended items. In the present disclosure, the terms “digital content” and “digital content work” are interchangeable. Herein, a digital content covers any electronic matter in digital form, including: electronic books in digital form; electronic children's books in digital form, electronic magazines in digital form; electronic articles in digital form; electronic dissertations in digital form; electronic academic papers in digital form; electronic opinions in digital form; electronic briefs in digital form; electronic statements in digital form; electronic declarations in digital form; electronic newsletters or newspapers in digital form; and any piece of literature, text, passages, work of fiction or non-fiction, represented in digital form and/or photographs in digital form.

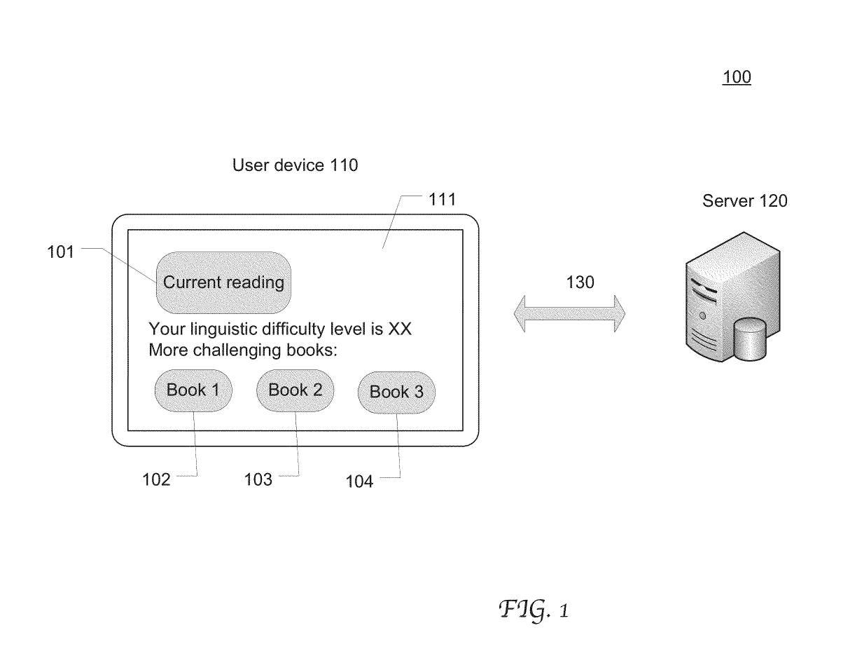

FIG. 1 illustrates an exemplary system 100 configured to automatically generate reading recommendations based on reading difficulty in accordance with an embodiment of the present disclosure. The system 100 includes a user device 110 coupled to a server device 120 through a network channel 130. The server device 120 is operable to discover recommendation books in response to a request received from the user device 110. The recommendation books may be presented to a user through a graphical user interface (GUI) 111 rendered on the user device 110. The user device 110 may be an electronic reading device on which a user can read books through a book reading program, or any other type of computing device. The server device may be hosted by a book store, an education institution, a library, a social network, or a reading club, etc.

A difficulty-based recommendation request is generated and sent from the user device 110 to the server device 120. For example, such a recommendation request can be automatically generated when a user finishes reading a book, or alternatively generated in response to a user instruction to discover more difficult books. In response, the server 120 can determine a preferred difficulty grade (or level) of the user by explicit and/or implicit user indications. The specified difficulty level can be input by the user interaction with a GUI of the application.

The server device 120 can identify candidate books for recommendation and access respective difficulty grades attached to them. Then the sever device 120 can automatically select books matching the user-preferred difficulty grade for recommendation. The selected books are then recommended through the GUI 111 rendered on the user device 110 in a recommendation event. Besides the recommendation books (102-104), the GUI 111 may also present to the user the estimated preferred difficulty level, as illustrated. Further, the user may be allowed to send a request through the GUI 111 to discover even more challenging books than presented.

It will be appreciated that a book reading program referred to herein may be used to display any type of digital contents that are mentioned above.

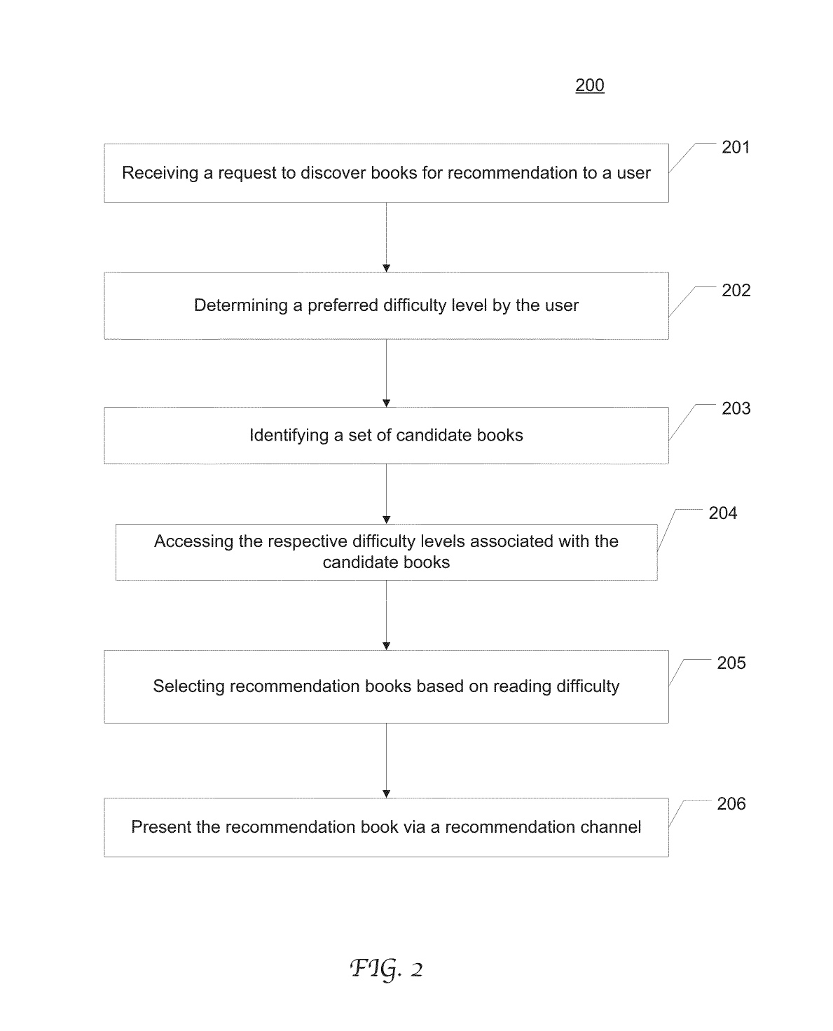

FIG. 2 is a flow chart depicting an exemplary computer implemented method 200 of automatically presenting difficulty-based recommendation books to target users in accordance with an embodiment of the present disclosure. Method 200 can be implemented as a software program on a server device, e.g., 120 in FIG. 1. At 201, a request is received to discover books for recommendation to a target user. As stated above, the request may be generated automatically or responsive to user input via a user interface. At 202, a preferred difficulty level or a specified difficulty level by the user is determined based on pertinent information. For example the preferred difficulty grade may be inferred from the difficulty levels of the books in the user's entire library, relevant information indicated in the user personal profile, and/or the user's reading history, or alike. A user may also directly input a preferred difficulty level, e.g., through the GUI 111.

At 203, a set of candidate books is automatically identified. Depending on various applications and implementations, the candidate books may include an entire library accessible to the user, or a particular book category in terms of classification, genre, subject matter, author, user group, or user rating, etc. Each candidate book is associated with a difficulty level or grade that is automatically determined in accordance with an embodiment of the present disclosure. In some embodiments, a difficulty level may correspond to a certain range of difficulty grades. At 204, the respective difficulty grades associated with the candidate books are accessed.

At 205, a list of books is automatically selected from the candidate book based on the difficulty grades. For instance, the candidate books matching the preferred difficulty level are selected. Further, an automatic filtering process may ensue to screen the recommendation selections, for example based on classification, genre, subject matter, author, user group, user rating rank, or etc. At 206, the recommendation books in the list are presented to the target user via a recommendation channel. The foregoing process 201-206 can be repeated for each target user.

Therefore, the selection of recommendation books is tailored to a specific user's capability or preference in terms of linguistic difficulty and complexity. This can advantageously enhance user reading experience as well as improve the marketing efficiency of a recommendation system.

A recommendation list generated in accordance with the present disclosure can be presented to a user through various recommendation channels, such as emails, on-line shopping websites, pop-up advertisements, electronic billboards, newspapers, electronic newspapers, magazines, etc. Moreover, it will be appreciated that automatically generating a recommendation list based on reading difficulty can be combined with any other suitable recommendation mechanism, such as based on content-relatedness, subject matter, title, author, rating, popularity, genre, promotion need and so on.

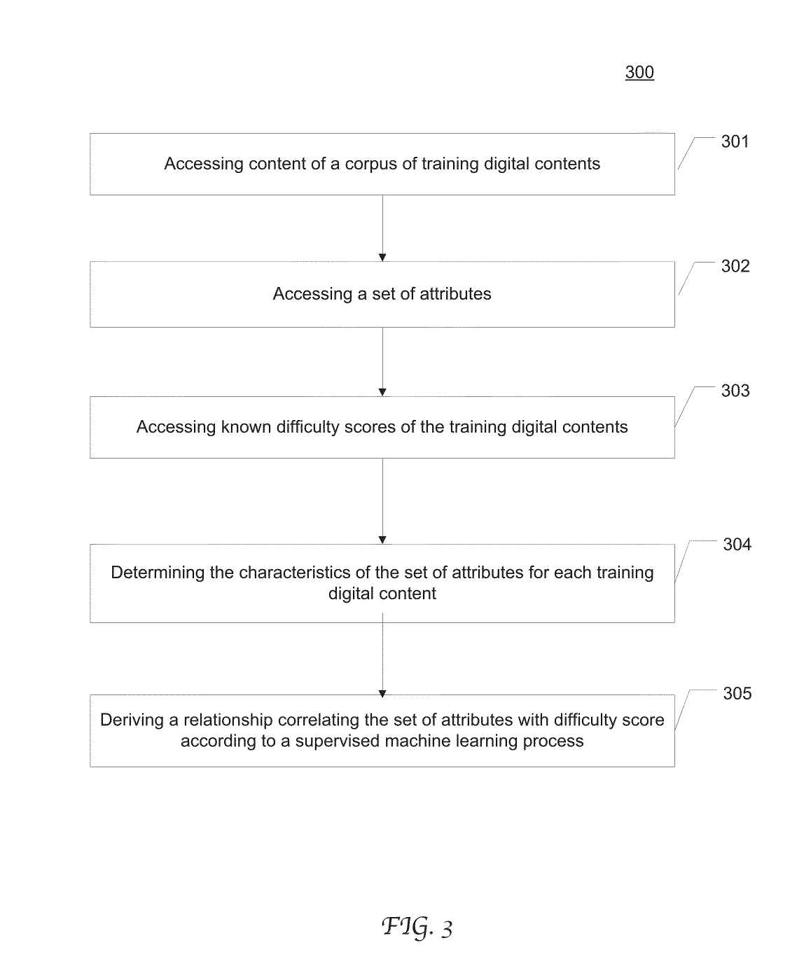

According to the present disclosure, a difficulty level of a digital content (e.g., a reference digital content or a candidate digital content in this context) can be determined using a mathematical relationship (or a difficulty model) that correlates certain digital content attributes (or features) with reading difficulty. FIG. 3 is a flow chart depicting an exemplary computer implemented method 300 of automatically establishing a difficulty model through a machine learning process in accordance with an embodiment of the present disclosure. Method 300 can be implemented as a separate software program or integrated in a recommendation generation program, e.g., 200 in FIG. 2.

At 301, the text content of a corpus of training digital contents are accessed. Each training digital content has a known difficulty grade or level which may be assigned manually or automatically by any suitable method or criteria that are well known in the art. At 302, a set of predefined digital content attributes are accessed. Embodiments of the present disclosure are not limited to any specific type of attribute indicative of reading difficulty of digital contents. The set of attributes includes linguistic attributes directly related to linguistic complexities, such as length of the digital content, average word length, average sentence length, vocabulary diversity, usage of verbs, usage of nouns, usage of adjectives, usage of bigrams and trigrams of parts of speech, frequency of parts of speech and frequency of punctuations. The set of attributes may also include reader behavior attributes indicative of reading difficulty, such as normalized reading time, rate of abandoning said recommendation digital content, and difficulty ratings by users.

At 303, the known difficulty scores of the training digital contents are accessed. At 304, for each digital content, characteristics of the set of attributes are determined. Characterizing each digital content against the set of attributes can be implemented in any suitable methods, algorithms, and processes that are well known in the art. Further, it will be appreciated that the relevant data can be represented in any suitable data structure. In one embodiment, characteristics of the set of attributes for each digital content are represented by a vector, with each element corresponding to a value of a specific attribute.

At 305, a relationship correlating the set of attributes with reading difficulty (or the difficulty model) is derived according to a machine learning process. Various machine learning algorithms and processes that are well known in the art can be used to derive a difficulty model according to the present disclosure. To name a few, such relationship can be derived from a decision tree process, an ensembles process, a linear regression process, a k-NN process, a Naive Bayes process, a neural network process, a logistic regression process, a support vector machine (SVM) process, a relevance vector machine (RVM) process, or a combination thereof. The foregoing process 301-305 is repeated upon the addition of new training digital contents or new reader behavior data for example.

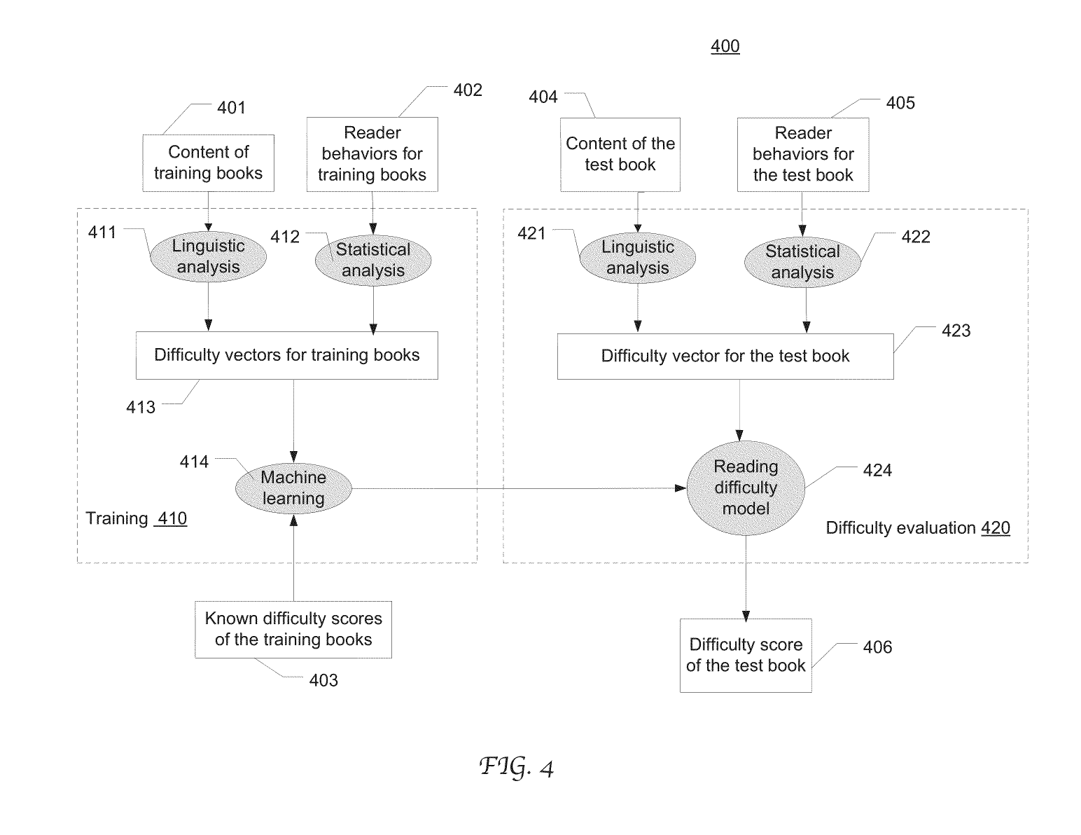

FIG. 4 is a block diagram illustrating an exemplary computer implemented process 400 of establishing a difficulty model and utilizing the model to determine a difficulty score of a book in accordance with an embodiment of the present disclosure. Method 400 can be implemented as a standalone software program or integrated in a recommendation program. The process primarily includes a training phase 410 and a difficulty evaluation phase 420.

In the training phase 410, the content of training books 401, the known difficulty scores of the training books 403 and reader behaviors data 402 with respect to the training books are processed to yield a reading difficulty model 424. Specifically, the content of the each training book 401 is subject to the automatic linguistic analysis 411 to obtain the characteristics (or values) of the predefined linguistic attributes, as described in greater detail above. Collected reader behavior data 302 for each training book is subject to statistical analysis 412 to obtain values of the predefined reader behavior attributes. Thus, each training book is represented by a difficulty vector 413 with each element corresponding to a value of a specific predefined attribute.

The difficulty vectors 413 and the known difficulty scores of the training books are analyzed using a machine learning process to produce a difficulty model 424. The difficulty model represents a generalized relationship between the set of predefined difficulty attributes and difficulty score.

In the difficulty evaluation phase 420, a test book is processed based on the reading difficulty model 424 to obtain a difficulty score. Specifically, the content 404 and reader behaviors data 405 are subject to linguistic analysis 421 and statistical analysis 422, respectively, resulting in a difficulty vector 423 specific to the test book. The vector 423 is then processed according to the reading difficulty model 424, thereby generating a difficulty score 406 of the test book. In some embodiments, the test book may be a candidate recommendation book or reference book indicative of a target user's preferred difficulty level.

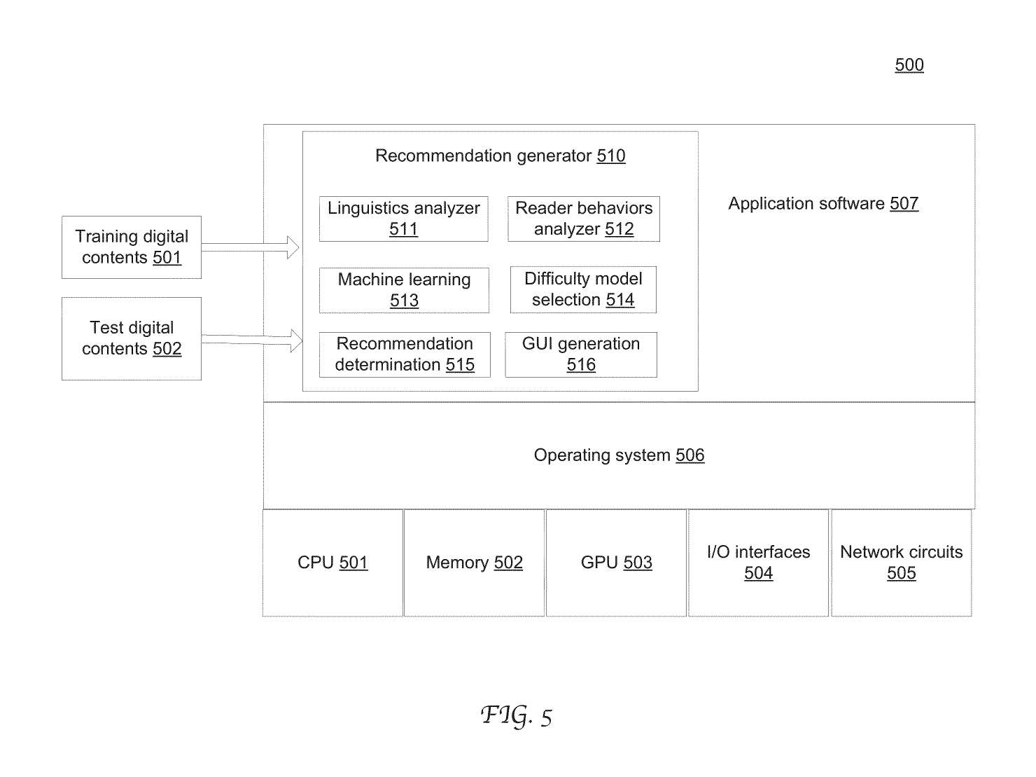

FIG. 5 is a block diagram illustrating an exemplary computing system 500 including an automated recommendation generator 510 in accordance with an embodiment of the present disclosure. The computing system 500 may be implemented on a server operable to provide reading recommendation services.

The computing system comprises a processor 501, system memory 502, a GPU 503, I/O interfaces 504 and network circuits 505, an operating system 506 and application software 507 including automated recommendation generator 510 stored in the memory 502. When incorporating programming configuration and user information collected through the Internet, the automated recommendation generator 510 can automatically generate a reading difficulty model as well as recommending digital contents based on the linguistic difficulty thereof.

The automated recommendation generator 510 may perform various functions and processes as discussed with reference to FIGS. 1-4. The automated recommendation generator 510 encompasses a linguistic analyzer 511, a reader behaviors analyzer 512, a machine learning module 513, a difficulty model selection 514, a recommendation determination module 515, and a GUI generation module 516.

The linguistic analyzer 511 can process text content of a digital content (e.g., training digital content 501 or test digital content 502) to obtain characteristics of the predefined linguistic attributes. The reader behavior analyzer 512 can access a reader behavior record with respect to the digital content, extract relevant data, and statistically analyze the data to obtain values of the predefined reader behavior attributes. The results produced from 511 and 512 for each digital content can be consolidated and represented by a difficulty vector. The machine learning module 513 can access the difficulty vectors and known difficulty scores of training digital contents and produce a difficulty model. In some embodiments, provided with the same corpus of training digital contents, the machine learning module 513 can produce more than one difficulty models by using a variety of machine learning processes that are well known in the art. The difficulty model selection module 514 can select optimal models in test phases based on the preset criteria. The recommendation determination module 515 can identify candidate digital contents, access difficulty scores of the candidate digital contents and select a list of recommendation digital contents (or reading recommendations) according to the preset criteria. The GUI generation module 516 can render an on-screen GUI, e.g., a webpage, to display the list of reading recommendations in a recommendation event.

As will be appreciated by those with ordinary skill in the art, the automated recommendation generator 510 may include any other suitable components and can be implemented in any one or more suitable programming languages that are known to those skilled in the art, such as C, C++, Java, Python, Perl, C#, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically discovering recommendation digital content works to a user, said method comprising:
receiving a request to recommend one or more digital content works to a user;
determining a preferred difficulty level by said user;
in response to said request, automatically identifying a recommendation digital content work based on said preferred difficulty level and a reading difficulty level of said recommendation digital content work; and
presenting said recommendation digital content work in a recommendation event.

2. The computer implemented method of claim 1 further comprising automatically determining said reading difficulty level of said recommendation digital content work based on characteristics of a set of linguistic attributes thereof.

3. The computer implemented method of claim 2, wherein said automatically determining said reading difficulty level of said recommendation digital content work comprises:
processing text content of said recommendation digital content work to determine said characteristics of said set of linguistic attributes;
accessing a correlation between said set of linguistics attributes and reading difficulty;
deriving a reading difficulty index of said recommendation digital content work based on said characteristics of said set of linguistic attributes and said correlation; and
determining said reading difficulty level based on said reading difficulty index.

4. The computer implemented method of claim 2, wherein said set of linguistic attributes are selected from a group consisting of digital content length, average word length, average sentence length, vocabulary diversity, usage of verbs, usage of nouns, usage of adjectives, usage of bigrams and trigrams of parts of speech, frequency of parts of speech and frequency of punctuations.

5. The computer implemented method of claim 2, wherein said automatically determining said reading difficulty level of said recommendation digital content work further comprises automatically determining said reading difficulty level based on statistics of reader behaviors with respect to said recommendation digital content work.

6. The computer implemented method of claim 6, wherein said reader behaviors are related to reading time, rate of abandoning said recommendation digital content work, and reader review.

7. The computer implemented method of claim 3, wherein said correlation is established using a machine leaning process.

8. The computer implemented method of claim 1, wherein said determining said preferred difficulty level comprises assessing a reading difficulty level of a currently-read digital content work by said user, and wherein further said reading difficulty level of said recommendation digital content work is greater than said reading difficulty level of said currently-read digital content work.

9. A computer implemented method of assessing linguistic difficulty of digital content works, said method comprising:
accessing contents of a corpus of digital content works, wherein each digital content work of said corpus is associated with a known difficulty score;
accessing a set of features related to linguistics difficulty of digital content works;
determining values of said set of features for said digital content work; and
based on known difficulty scores of said corpus of digital content works and values of said set of features for said corpus of digital content works, determining a relationship correlating said set of features and linguistic difficulty in accordance with a machine learning process.

10. The computer implemented method of claim 9, wherein said set of features are selected from a group consisting of digital content work length, average word length, average sentence length, usage of verbs, vocabulary diversity, usage of nouns, usage of adjectives, usage of bigrams and trigrams of parts of speech, frequency of parts of speech and frequency of punctuations.

11. The computer implemented method of claim 9, said values of said set of features for said digital content work are automatically determined by processing content thereof and are represented by a vector, and wherein further each element of said vector corresponds to a values of a respective feature of said set of features.

12. The computer implemented method of claim 9, wherein said corpus of digital content works are selected from a group consisting of books, magazines, articles, dissertations, papers, and news.

13. The computer implemented method of claim 9, wherein said machine learning process is selected from a group consisting of a decision tree process, an ensemble method, a linear regression process, a k-NN process, a Naive Bayes process, a neural network process, a logistic regression process, a support vector machine (SVM) process, a relevance vector machine (RVM) process, and a combination thereof.

14. The computer implemented method of claim 9 further comprising:
processing content of a candidate digital content work to derive values of said set of features for said candidate digital content work; and
deriving a difficulty score for said candidate digital content work based on said values of said set of features for said candidate digital content work and said relationship.

15. A system comprising:
a processor; and
memory coupled to said processor and comprising instructions that, when executed by said processor, cause the processor to perform a method of generating reading recommendations to users, said method comprising:
receiving a request to generate a plurality of recommendation digital content works to a user;
determining a preferred difficulty level by said user;
responsive to said request, automatically identifying a recommendation digital content work based on said preferred difficulty level and a reading difficulty level of said recommendation digital content work;
rendering an on-screen graphical user interface (GUI) for display; and
presenting said recommendation digital content work within said on-screen GUI.

16. The system of claim 15, wherein said reading difficulty level of said recommendation digital content work is determined by:
processing text content of said recommendation digital content work to determine characteristics of a set of linguistic attributes;
accessing a correlation between said set of linguistics attributes and reading difficulty index;
deriving a reading difficulty index for said recommendation digital content work based on said characteristics of said set of linguistic attributes and said correlation; and
determining said reading difficulty level of said recommendation digital content work based on said reading difficulty index for said recommendation digital content work.

17. The system of claim 15, wherein said set of linguistic attributes are selected from a group consisting of digital content work length, average word length, average sentence length, usage of verbs, usage of nouns, usage of adjectives, usage of bigrams and trigrams of parts of speech, frequency of parts of speech and frequency of punctuations.

18. The system of claim 17, wherein said automatically determining said reading difficulty level of said recommendation digital content work further comprises automatically determining said reading difficulty level of said recommendation digital content work based on statistics of reader behaviors with respect to said recommendation digital content work, and wherein further said reader behaviors are related to reading time, rate of abandoning said recommendation digital content work, and reader review.

19. The system of claim 17, wherein the correlation is established through a supervised machine leaning process based on a corpus of training digital content works with known reading difficulty levels.

20. The system of claim 17, wherein said determining said preferred difficulty level comprises accessing a reading difficulty level of a reference digital content work selected from a group consisting of a current reading of said user, a digital content work in a library associated with said user, and a recently reviewed digital content work by said user.
